(19) United States
(12) Patent Application Publication
(10) Pub. No.: US 2017/0366638 A1
(43) Pub. Date: Dec. 21, 2017

(54) METHOD OF CONTROLLING A VIRTUAL MACHINE, INFORMATION PROCESSING APPARATUS AND NON-TRANSITORY COMPUTER-READABLE STORAGE MEDIUM

(71) Applicant: FUJITSU LIMITED, Kawasaki-shi (JP)

(72) Inventor: KAZUHIRO SUZUKI, Kawasaki (JP)

(73) Assignee: FUJITSU LIMITED, Kawasaki-shi (JP)

(21) Appl. No.: 15/608,445

(22) Filed: May 30, 2017

(30) Foreign Application Priority Data
Jun. 20, 2016 (JP) 2016-122109

(51) Int. Cl. H04L 29/08; G06F 9/455; G06F 12/0893; G06F 15/167; G06F 9/50

(52) U.S. Cl. CPC H04L 67/2842; G06F 9/45558; G06F 12/0893; G06F 9/5061; G06F 2009/4557; G06F 2009/45583; G06F 15/167

(57) ABSTRACT

A method of controlling a first virtual machine and a second virtual machine, the method includes detecting that the second virtual machine is in a suspended state, storing one or more first packets into a first buffer during the suspended state, inputting the one or more first packets stored in the first buffer into a second buffer after the suspended state is ended, generating one or more second packets by replicating the one or more first packets input from the first buffer to the second buffer, transmitting the one or more first packets stored in the second buffer to the first virtual machine, and transmitting the one or more second packets to the second virtual machine.

### CROSS-REFERENCE TO RELATED APPLICATION

This application is based upon and claims the benefit of priority of the prior Japanese Patent Application No. 2016-122109, filed on Jun. 20, 2016, the entire contents of which are incorporated herein by reference.

### FIELD

The embodiment relates to a method of controlling a virtual machine, an information processing apparatus and a non-transitory computer-readable storage medium.

### BACKGROUND

There is a technique of port mirroring in which, when packets are transmitted or received by a target virtual machine (VM) through a specific port a virtual switch includes, mirror packets obtained by replicating the packets transmitted or received by the target VM are generated and are forwarded to a monitor VM through another port.

As related arts, for example, there is a technique in which writing is carried out also to a calculator of a memory copying destination in memory writing to an area in which memory copying has been carried out and memory writing to an area in which memory copying is being carried out is merged with memory writing for the memory copying. Furthermore, for example, there is a technique in which a monitoring device is instructed to acquire configuration information if the occurrence of change in the correspondence relationship between a physical server and a virtual machine is recognized as the result of collection of packets obtained by mirroring from packets that flow among plural virtual machines and analysis of traffic and route information. As related-art documents, there are Japanese Laid-open Patent Publication No. 2011-221945 and Japanese Laid-open Patent Publication No. 2012-4781.

### SUMMARY

According to an aspect of the embodiment, a method of controlling a first virtual machine and a second virtual machine, the method includes detecting that the second virtual machine is in a suspended state, storing one or more first packets into a first buffer during the suspended state, inputting the one or more first packets stored in the first buffer into a second buffer after the suspended state is ended, generating one or more second packets by replicating the one or more first packets input from the first buffer to the second buffer, transmitting the one or more first packets stored in the second buffer to the first virtual machine, and transmitting the one or more second packets to the second virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating one embodiment example of a mirror packet control method according to an embodiment;

FIG. 2 is an explanatory diagram illustrating one example of a port mirroring system 200;

FIG. 3 is a block diagram illustrating a hardware configuration example of a mirror packet control device 100;

FIG. 4 is an explanatory diagram illustrating one example of stored contents of a VM state management table 400;

FIG. 5 is an explanatory diagram illustrating one example of stored contents of a ring buffer management table 500;

FIG. 6 is an explanatory diagram illustrating one example of stored contents of a mirror packet buffer 600;

FIG. 7 is a block diagram illustrating a functional configuration example of the mirror packet control device 100;

FIG. 8 is an explanatory diagram illustrating a module configuration example of the port mirroring system 200;

FIG. 9 is an explanatory diagram (first diagram) illustrating operation example 1 of the port mirroring system 200;

FIG. 10 is an explanatory diagram (second diagram) illustrating operation example 1 of the port mirroring system 200;

FIG. 11 is an explanatory diagram (third diagram) illustrating operation example 1 of the port mirroring system 200;

FIG. 12 is an explanatory diagram (fourth diagram) illustrating operation example 1 of the port mirroring system 200;

FIG. 13 is a flowchart illustrating one example of a state management processing procedure;

FIG. 14 is a flowchart illustrating one example of an interrupt setting processing procedure;

FIG. 15 is a flowchart illustrating one example of an interrupt cancellation processing procedure;

FIG. 16 is a flowchart illustrating one example of an interrupt processing procedure;

FIG. 17 is a flowchart illustrating one example of a packet processing procedure;

FIG. 18 is a flowchart illustrating one example of a mirroring processing procedure;

FIG. 19 is a sequence diagram illustrating one example of the flow of operation when a monitor VM 802 suspends;

FIG. 20 is a sequence diagram illustrating one example of the flow of operation when suspension of the monitor VM 802 is released;

FIG. 21 is an explanatory diagram illustrating operation example 2 of the port mirroring system 200;

FIG. 22 is a flowchart illustrating one example of a determination processing procedure;

FIG. 23 is an explanatory diagram illustrating operation example 3 of the port mirroring system 200; and

FIG. 24 is a flowchart illustrating one example of a state determination processing procedure.

### DESCRIPTION OF EMBODIMENT

There is the case in which it is difficult for the monitor VM to receive mirror packets. For example, the monitor VM often temporarily suspends when carrying out live migration. Mirror packets obtained by replicating packets transmitted or received by the target VM when the monitor VM is under suspension are not received by the monitor VM and are lost.

A mirror packet control program, a mirror packet control method, and a mirror packet control device according to an embodiment of the present disclosure will be described in detail below with reference to the drawings.

(One Embodiment Example of Mirror Packet Control Method According to Embodiment)

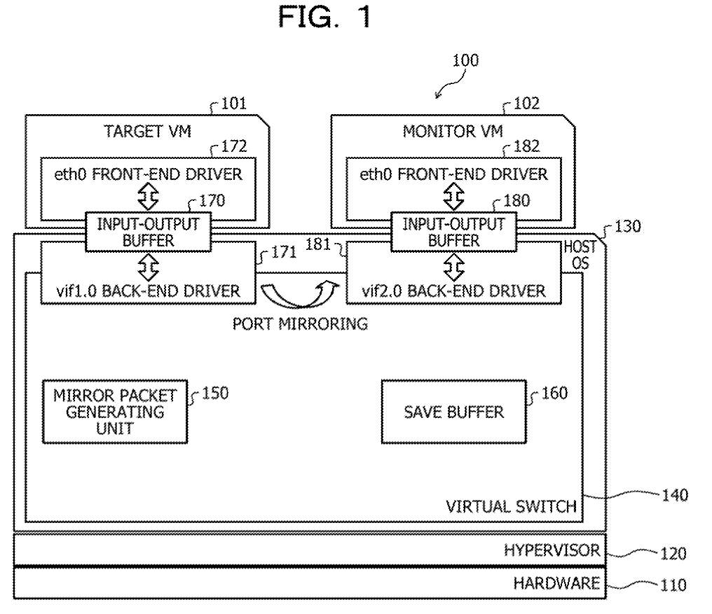

FIG. 1 is an explanatory diagram illustrating one embodiment example of a mirror packet control method according to an embodiment. Here, a mirror packet control device 100 is a computer that includes a virtual switch and implements port mirroring.

Here, for example, the case is conceivable in which a virtual switch forwards mirror packets obtained by replicating packets transmitted or received by the virtual switch through a port to a first virtual machine from the virtual switch through a port to a second virtual machine. In the following description, the first virtual machine will be often represented as the “target VM.”Furthermore, in the following description, the second virtual machine will be often represented as the “monitor VM.”

However, in this case, it is difficult for the monitor VM to receive the mirror packets in some cases. For example, the monitor VM often temporarily suspends when carrying out live migration or the like. Mirror packets obtained by replicating packets transmitted or received by the target VM when the monitor VM is under suspension are not received by the monitor VM and are lost. Furthermore, it is also difficult for the monitor VM to request retransmission regarding the mirror packets.

In contrast, the case in which reception of the mirror packets by the monitor VM is facilitated is conceivable as represented in the following (a) and (b). However, even in this case, it is often difficult for the monitor VM to receive the mirror packets or the lowering of the performance of the virtual switch is often caused, which is not preferable.

(a) For example, the case in which the target VM is suspended while the monitor VM is carrying out live migration is conceivable. In this case, transmission of packets from the target VM during the period in which the monitor VM is carrying out the live migration may be suppressed, so that transmission of mirror packets obtained by replicating the packets transmitted from the target VM may be suppressed. However, in this case, transmission of packets to the target VM during the period in which the monitor VM is carrying out the live migration is not suppressed. For this reason, mirror packets obtained by replicating the packets transmitted to the target VM are transmitted to the monitor VM under suspension, so that the mirror packets are not received by the monitor VM and are lost in some cases.

(b) For example, the case is conceivable in which packets transmitted or received by the virtual switch through a port to the target VM are temporarily stored in a save buffer and the packets taken out from the save buffer are transmitted or received by the virtual switch through the port to the target VM. However, in this case, packets are temporarily stored in the save buffer. Thus, increase in the time it takes to transmit or receive packets by the virtual switch through the port to the target VM is caused and the lowering of the performance of the virtual switch is often caused.

Thus, in the present embodiment, description will be made about a mirror packet control method that may reduce the probability of loss of mirror packets by suppressing transmission of the mirror packets when the monitor VM is under suspension while suppressing the lowering of the performance of the virtual switch.

In the example of FIG. 1, a hypervisor 120 is executed in hardware 110 of the mirror packet control device 100. In the hypervisor 120, a host operating system (OS) 130 is executed. In the host OS 130, a target VM 101 and a monitor VM 102 are executed.

The host OS 130 includes a virtual switch 140. The host OS 130 includes a back-end driver 171 that controls access to an input-output buffer 170 that exists in a storage area possessed by the hypervisor 120 and is used for input and output of packets about the target VM 101. Furthermore, the host OS 130 includes a back-end driver 181 that controls access to an input-output buffer 180 that exists in a storage area possessed by the hypervisor 120 and is used for input and output of packets about the monitor VM 102.

The target VM 101 includes a front-end driver 172 that controls access to the input-output buffer 170 that exists in the storage area possessed by the hypervisor 120 and is used for input and output of packets about the target VM 101. The monitor VM 102 includes a front-end driver 182 that controls access to the input-output buffer 180 that exists in the storage area possessed by the hypervisor 120 and is used for input and output of packets about the monitor VM 102. The back-end driver and the front-end driver are collectively referred to as a para virtual (PV) driver. The virtual switch 140 includes a mirror packet generating unit 150. The virtual switch 140 includes a save buffer 160.

The virtual switch 140 carries out control so that packets about the target VM 101 may be input and output through the input-output buffer 170. For example, the virtual switch 140 causes the packets about the target VM 101 to be input and output by coordinated operation of the back-end driver 171 in the host OS 130 and the front-end driver 172 in the target VM 101.

For example, the virtual switch 140 inputs a packet to the target VM 101 by registering the packet in the input-output buffer 170. Furthermore, the virtual switch 140 outputs a packet from the target VM 101 by taking out the packet registered in the input-output buffer 170 by the target VM 101. The registration refers to storing a packet and an input/output notification of the packet in the input-output buffer.

Thereby, the virtual switch 140 implements a port leading to the target VM 101. In the example of FIG. 1, the port leading to the target VM 101 is given a name vif1.0. In the example of FIG. 1, a port leading to the virtual switch 140 in the target VM 101 is given a name eth0. The virtual switch 140 implements a port leading to the monitor VM 102 similarly. In the example of FIG. 1, the port leading to the monitor VM 102 is given a name vif2.0. In the example of FIG. 1, a port leading to the virtual switch 140 in the monitor VM 102 is given a name eth0. The names of ports in different VMs may overlap.

In response to input or output of a packet registered in the input-output buffer 170, the mirror packet generating unit 150 transmits a mirror packet obtained by replicating the packet registered in the input-output buffer 170 to the monitor VM 102. For this reason, there is a possibility that, even when the monitor VM 102 is in the suspended state, the mirror packet generating unit 150 transmits a mirror packet to the monitor VM 102 when a packet registered in the input-output buffer 170 is input or output.

Thus, in the example of FIG. 1, the virtual switch 140 carries out control to keep packets from remaining registered in the input-output buffer 170 while the monitor VM 102 is in the suspended state, and reregisters the packet in the input-output buffer 170 after the monitor VM 102 is released from the suspended state.

(1-1) The virtual switch 140 detects the suspended state of the monitor VM 102. The suspended state is the state in which it is difficult for the monitor VM 102 to receive packets. For example, the suspended state is the state in which the monitor VM 102 temporarily makes transition immediately before completing live migration. The suspended state may be a state in a case other than the case in which the monitor VM 102 carries out live migration. This allows the virtual switch 140 to detect that the present state is the state in which the monitor VM 102 is under suspension and possibly a mirror packet obtained by replicating a packet registered in the input-output buffer 170 is lost if the mirror packet is transmitted to the monitor VM 102.

(1-2) The virtual switch 140 accumulates packets that become targets of input and output regarding the target VM 101 in the period from detection of the suspended state to release of the suspended state in the save buffer 160 different from the input-output buffer 170. The release of the suspended state is carried out through the completion of live migration by the monitor VM 102, for example. For example, the virtual switch 140 moves packets once registered in the input-output buffer 170 to the save buffer 160 before reading out and forwarding the packets or before the target VM 101 reads out the packets, and deletes the packets from the input-output buffer 170.

This allows the virtual switch 140 to suppress input and output to and from the target VM 101 regarding the packets registered in the input-output buffer 170. Furthermore, the virtual switch 140 may suppress transmission of mirror packets obtained by replicating the packets registered in the input-output buffer 170 to the monitor VM 102 in the suspended state by the mirror packet generating unit 150.

(1-3) When the suspended state is released, the virtual switch 140 reregisters the packets accumulated in the save buffer 160 in the input-output buffer 170. Furthermore, the virtual switch 140 registers, in the input-output buffer 170, packets that become targets of input and output regarding the target VM 101 after the suspended state is released. This allows the virtual switch 140 to resume input and output of packets to and from the target VM 101 and also resume transmission of mirror packets to the monitor VM 102 in response to the resumption of input and output of packets to and from the target VM 101.

This allows the virtual switch 140 to carry out input and output of packets registered in the input-output buffer 170 to and from the target VM 101 if the monitor VM 102 is not in the suspended state, enabling suppression of the lowering of the performance. Furthermore, when the monitor VM 102 becomes the suspended state, the virtual switch 140 suppresses transmission of mirror packets to the monitor VM 102 under suspension, which may reduce the probability at which the mirror packets are not received by the monitor VM 102 and are lost.

Moreover, after the suspended state of the monitor VM 102 is released, the virtual switch 140 may carry out input and output of packets reregistered in the input-output buffer 170 to and from the target VM 101. Furthermore, in response to the input and output of the packets reregistered in the input-output buffer 170, the virtual switch 140 may transmit mirror packets obtained by replicating the packets reregistered in the input-output buffer 170 to the monitor VM 102 in which the suspended state has been released.

(One Example of Port Mirroring System 200)

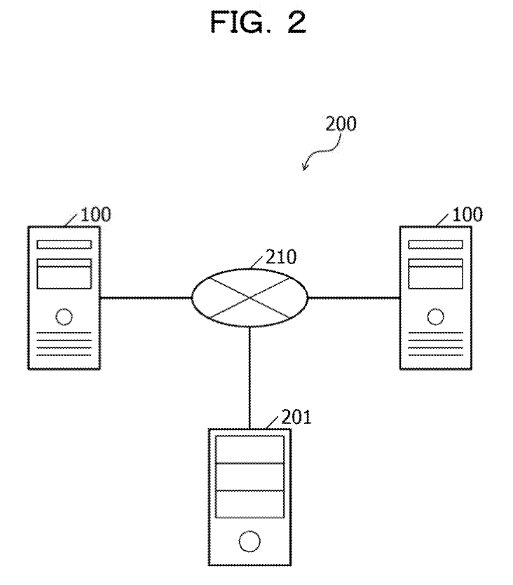

Next, one example of a port mirroring system 200 to which the mirror packet control device 100 illustrated in FIG. 1 is applied will be described by using FIG. 2.

FIG. 2 is an explanatory diagram illustrating the one example of the port mirroring system 200. In FIG. 2, the port mirroring system 200 includes plural mirror packet control devices 100 and a management device 201. In the port mirroring system 200, the plural mirror packet control devices 100 and the management device 201 are coupled through a wired or wireless network 210. The network 210 is a local area network (LAN), a wide area network (WAN), the Internet or the like, for example.

The mirror packet control device 100 is a computer that implements port mirroring while carrying out control to keep the mirror packet from being transmitted to the monitor VM 102 while the monitor VM 102 is in the suspended state as illustrated in FIG. 1. The mirror packet control device 100 is a server, for example. The virtual switches 140 included by the respective mirror packet control devices 100 are coupled through a virtual local area network (VLAN), for example. In the following description, in the case of discriminating the respective mirror packet control devices 100, the mirror packet control device 100 will be often represented as the “mirror packet control device 100-i.” i is an integer of 1 to n. n is the number of mirror packet control devices 100.

The management device 201 is a computer that executes a port mirror manager. For example, the port mirror manager monitors whether or not VMs in the respective mirror packet control devices 100 are in the suspended state and manages the state of the VMs in the respective mirror packet control devices 100. For example, the port mirror manager makes setting about which packets of packets to be input and packets to be output regarding the target VM 101 are to be replicated and be transmitted to the monitor VM 102, and manages the port mirroring. The management device 201 is a server, for example. Although the case in which the management device 201 is a device different from the mirror packet control device 100 is described here, the configuration is not limited thereto. For example, the management device 201 may be integrated with any mirror packet control device 100.

(Hardware Configuration Example of Mirror Packet Control Device 100)

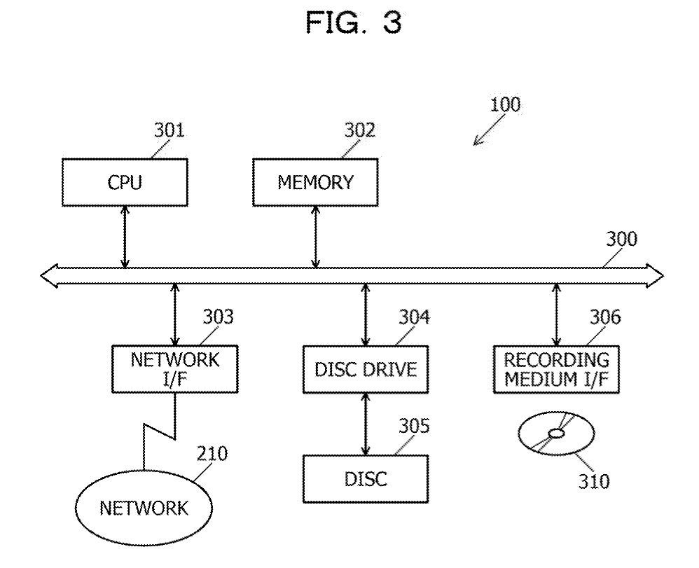

Next, a hardware configuration example of the mirror packet control device 100 included in the port mirroring system 200 illustrated in FIG. 2 will be described by using FIG. 3.

FIG. 3 is a block diagram illustrating the hardware configuration example of the mirror packet control device 100. In FIG. 3, the mirror packet control device 100 includes a central processing unit (CPU) 301, a memory 302, a network interface (I/F) 303, a disc drive 304, a disc 305, and a recording medium I/F 306. Furthermore, the respective constituent units are coupled to each other by a bus 300.

Here, the CPU 301 is responsible for overall control of the mirror packet control device 100. The memory 302 includes a read only memory (ROM), a random access memory (RAM), a flash ROM and so forth, for example. For example, the flash ROM and the ROM store various kinds of programs and the RAM is used as a work area of the CPU 301. The various kinds of programs may include the mirror packet control program according to the embodiment, for example. The program stored in the memory 302 is loaded into the CPU 301 to thereby cause the CPU 301 to execute coded processing.

The network I/F 303 is coupled to the network 210 through a communication line and is coupled to other computers through the network 210. Furthermore, the network I/F 303 is responsible for the network 210 and the internal interface and controls input and output of data from and to other computers. The network I/F 303 is a modem, a LAN adapter or the like, for example.

The disc drive 304 controls reading/writing of data from/to the disc 305 in accordance with control by the CPU 301. The disc drive 304 is a magnetic disc drive, for example. The disc 305 is a non-volatile memory that stores data written under control by the disc drive 304. The disc 305 is a magnetic disc or an optical disc, for example.

The recording medium I/F 306 is coupled to an external recording medium 310 and is responsible for the external recording medium 310 and the internal interface, and controls input and output of data from and to the external recording medium 310. The recording medium I/F 306 is a universal serial bus (USB) port, for example. The external recording medium 310 is a USB memory, for example. The external recording medium 310 may store the mirror packet control program according to the embodiment.

The mirror packet control device 100 may include, besides the above-described constituent units, a solid state drive (SSD), a semiconductor memory, a keyboard, a mouse, a display and so forth, for example. Furthermore, the mirror packet control device 100 may include an SSD, a semiconductor memory and so forth instead of the disc drive 304 and the disc 305.

(Hardware Configuration Example of Management Device 201)

Here, a hardware configuration example of the management device 201 is similar to the hardware configuration example of the mirror packet control device 100 illustrated in FIG. 3 and therefore description is omitted.

(Stored Contents of VM State Management Table 400)

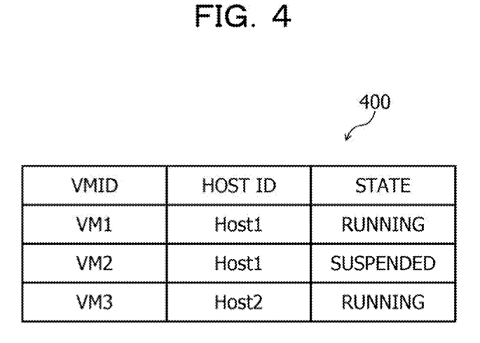

Next, one example of stored contents of a VM state management table 400 will be described by using FIG. 4. The VM state management table 400 is implemented by a storage area of the management device 201, for example.

FIG. 4 is an explanatory diagram illustrating the one example of the stored contents of the VM state management table 400. As illustrated in FIG. 4, the VM state management table 400 includes fields of a VM identifier (ID), a host ID, and the state. In the VM state management table 400, information is set in each field on each VM basis and thereby VM state management information is stored as records.

In the field of the VM ID, the VM ID that is information with which the VM is uniquely identified is set. In the field of the host ID, the host ID that is information with which the host OS is uniquely identified is set. In the field of the state, the state of the VM is set. For example, the state of the VM is “RUNNING” when the VM is in operation, and is “SUSPENDED” when the VM is under suspension.

The VM state management table 400 is generated and updated by the management device 201. The management device 201 may manage the state of the VMs in the respective mirror packet control devices 100 by using the VM state management table 400. Furthermore, by referring to the VM state management table 400, the management device 201 may notify the mirror packet control device 100 that is currently executing the target VM 101 of that the state of the monitor VM 102 has become the suspended state. Moreover, by referring to the VM state management table 400, the management device 201 may notify the mirror packet control device 100 that is currently executing the target VM 101 of that the state of the monitor VM 102 has returned from the suspended state to the running state.

(Stored Contents of Ring Buffer Management Table 500)

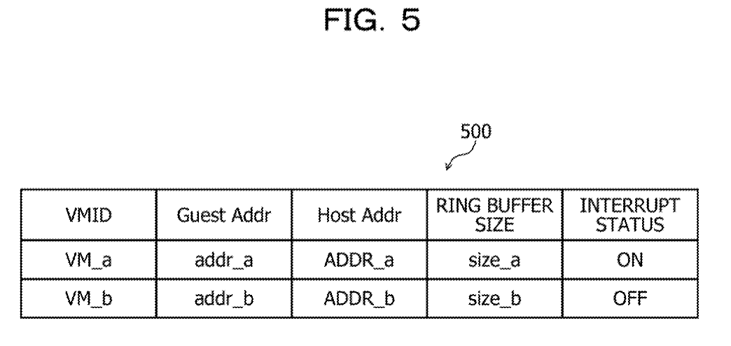

Next, one example of stored contents of a ring buffer management table 500 will be described by using FIG. 5. For example, the ring buffer management table 500 is implemented by a storage area of the memory 302 or the disc 305 of the mirror packet control device 100 illustrated in FIG. 3.

Here, the ring buffer is a storage area used for input and output of packets about any VM. For example, the ring buffer corresponds to the input-output buffer 170 illustrated in FIG. 1 and is a storage area serving as part of the input-output buffer 170 illustrated in FIG. 1. An input ring buffer used for input of packets and an output ring buffer used for output of packets may separately exist.

FIG. 5 is an explanatory diagram illustrating the one example of the stored contents of the ring buffer management table 500. As illustrated in FIG. 5, the ring buffer management table 500 includes fields of a VM ID, Guest Addr, Host Addr, the ring buffer size, and an interrupt status. In the ring buffer management table 500, information is set in each field on each VM basis and thereby ring buffer management information is stored as records.

In the field of the VM ID, the VM ID that is information with which the VM serving as a guest OS is uniquely identified is set. In the field of Guest Addr, Guest Addr that is an address for identification of the ring buffer by the VM serving as a guest OS is set. If an input ring buffer used for input of packets and an output ring buffer used for output of packets separately exist, Guest Addr corresponding to a respective one of the ring buffers may be set in the field of Guest Addr.

In the field of Host Addr, Host Addr that is an address for identification of the ring buffer by the host OS is set. If an input ring buffer used for input of packets and an output ring buffer used for output of packets separately exist, Host Addr corresponding to a respective one of the ring buffers may be set in the field of Host Addr.

In the field of the ring buffer size, the size of the ring buffer about the VM serving as a guest OS is set. If an input ring buffer used for input of packets and an output ring buffer used for output of packets separately exist, the sizes of the respective ring buffers may be set in the field of the ring buffer size. In the field of the interrupt status, a flag indicating whether or not the present state is the state in which an interrupt is made to input and output of packets about the VM serving as a guest OS is set. For example, the interrupt status is “ON” when the present state is the state in which an interrupt is made, and is “OFF” when the present state is the state in which an interrupt is not made.

The ring buffer management table 500 is generated and updated by the mirror packet control device 100. The mirror packet control device 100 may manage the ring buffer corresponding to the VM by using the ring buffer management table 500. Furthermore, with reference to the ring buffer management table 500, the mirror packet control device 100 may make setting in the hypervisor 120 to generate an interrupt when writing to the ring buffer is carried out.

(Stored Contents of Mirror Packet Buffer 600)

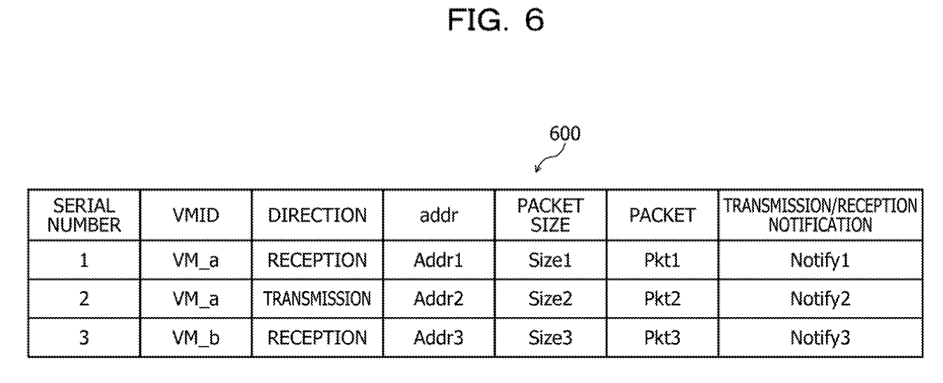

Next, one example of stored contents of a mirror packet buffer 600 will be described by using FIG. 6. For example, the mirror packet buffer 600 is implemented by a storage area of the memory 302 or the disc 305 of the mirror packet control device 100 illustrated in FIG. 3.

FIG. 6 is an explanatory diagram illustrating the one example of the stored contents of the mirror packet buffer 600. As illustrated in FIG. 6, the mirror packet buffer 600 includes fields of a serial number, the VM ID, the direction, addr, the packet size, a packet, and a transmission/reception notification. In the mirror packet buffer 600, information is set in each field on each packet basis and thereby mirror packet control information is stored as records.

In the field of the serial number, the serial number that is a record number is set. In the field of the VM ID, the VM ID that is information with which the VM is uniquely identified is set. In the field of the direction, the communication direction of the packet with respect to the VM is set. For example, the direction is “reception” when the VM is caused to receive the packet, and is “transmission” when the packet is transmitted from the VM. In the field of addr, the destination of the packet is set. In the field of the packet size, the size of the packet is set. In the field of the packet, the body of the packet is set. In the field of the transmission/reception notification, an output notification to request transmission of the packet or an input notification to request reception of the packet is set.

The mirror packet buffer 600 is generated by the mirror packet control device 100. The mirror packet control device 100 may save packets from the ring buffer to the mirror packet buffer 600 while the monitor VM 102 is under suspension and keep mirror packets from being transmitted to the monitor VM 102 under suspension. For example, the mirror packet control device 100 may accumulate, in the mirror packet buffer 600, pieces of information used in reregistering packets in the ring buffer.

(Functional Configuration Example of Mirror Packet Control Device 100)

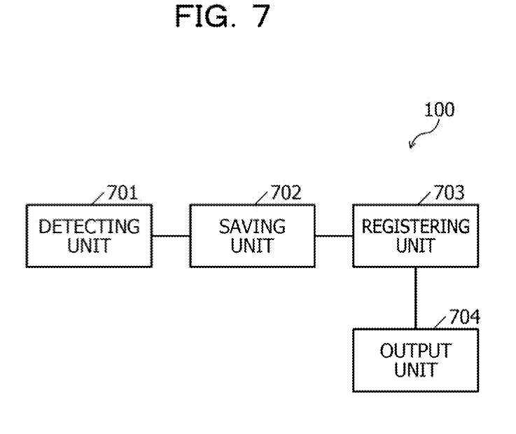

Next, a functional configuration example of the mirror packet control device 100 will be described by using FIG. 7. FIG. 7 is a block diagram illustrating the functional configuration example of the mirror packet control device 100. The mirror packet control device 100 includes a detecting unit 701, a saving unit 702, a registering unit 703, and an output unit 704.

The detecting unit 701 to the output unit 704 are functions serving as a control unit, and the functions are implemented by causing the CPU 301 to execute the program stored in a storage area of the memory 302, the disc 305 or the like illustrated in FIG. 3 or through the network I/F 303, for example. Processing results by the respective functional units are stored in the storage area of the memory 302, the disc 305 or the like illustrated in FIG. 3, for example.

The detecting unit 701 detects the suspended state of a second virtual machine to which mirror packets obtained by replicating packets registered in the input-output buffer 170 used for input and output regarding a first virtual machine are output. The first virtual machine is a VM that is coupled to the virtual switch 140 and to and from which packets are input and output. The first virtual machine is the target VM 101, for example.

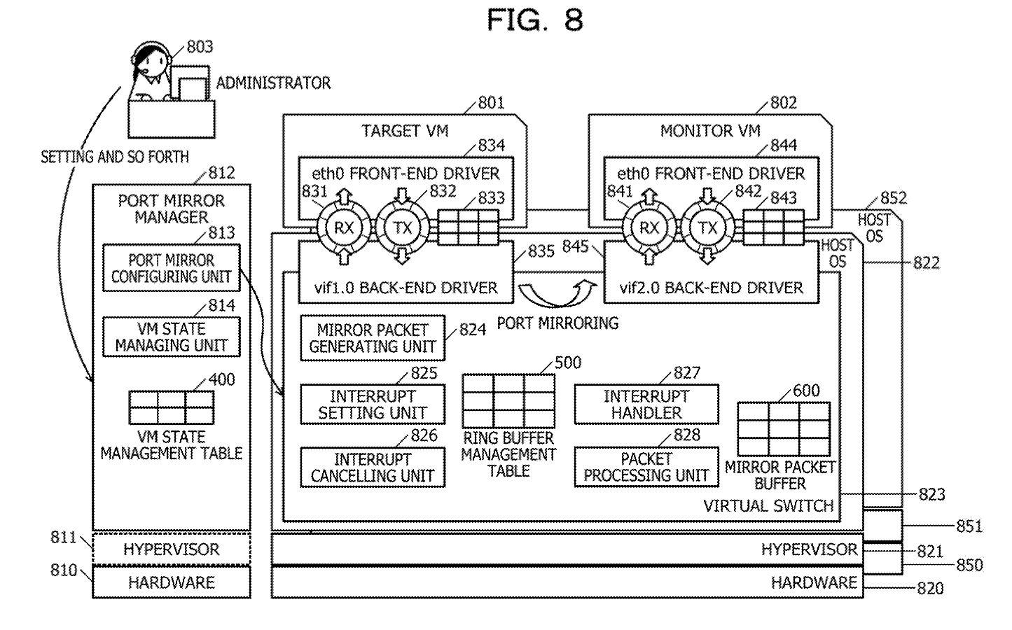

The input-output buffer 170 is a storage area used for input and output of packets about the target VM 101. The input-output buffer 170 is a combination of an input ring buffer, an output ring buffer, and a packet buffer, for example. The input ring buffer is a storage area that stores the input notifications of packets. The output ring buffer is a storage area that stores output notifications of packets. The packet buffer is a storage area that stores packets that become targets of input and output. The input ring buffer, the output ring buffer, and the packet buffer will be described later with FIG. 8.

The second virtual machine is a VM that is coupled to the virtual switch 140 and to which mirror packets are output. The second virtual machine may not be directly coupled to the virtual switch 140, for example. The second virtual machine may be coupled to another virtual switch 140 to which the virtual switch 140 leads from any port of the virtual switch 140. The second virtual machine is the monitor VM 102, for example.

For example, the detecting unit 701 detects the suspended state of the second virtual machine in response to the start of live migration by the second virtual machine from an arithmetic device in operation to another arithmetic device. The arithmetic device is the mirror packet control device 100, for example. For example, when the monitor VM 102 starts live migration, the detecting unit 701 detects that the monitor VM 102 has become the suspended state. For example, the detecting unit 701 may detect that the monitor VM 102 has become the suspended state by being notified of the state of the monitor VM 102 from the management device 201. For example, the detecting unit 701 may detect that the monitor VM 102 has become the suspended state by carrying out polling to the monitor VM 102.

For example, in the case in which the second virtual machine carries out live migration from an arithmetic device in operation to another arithmetic device, the detecting unit 701 may monitor the amount of transfer of information relating to the second virtual machine from the arithmetic device in operation to the other arithmetic device. Furthermore, the detecting unit 701 detects the suspended state of the second virtual machine in response to falling of the amount of transfer below a threshold. This allows the detecting unit 701 to detect that the present state is the state in which the monitor VM 102 is under suspension and possibly a mirror packet is lost if the mirror packet is transmitted to the monitor VM 102.

The detecting unit 701 detects release of the suspended state of the second virtual machine. For example, the detecting unit 701 detects release of the suspended state of the monitor VM 102. For example, the detecting unit 701 detects that the monitor VM 102 has been released from the suspended state by being notified of the state of the monitor VM 102 from the management device 201. For example, the detecting unit 701 may detect release of the suspended state of the monitor VM 102 by carrying out polling to the monitor VM 102.

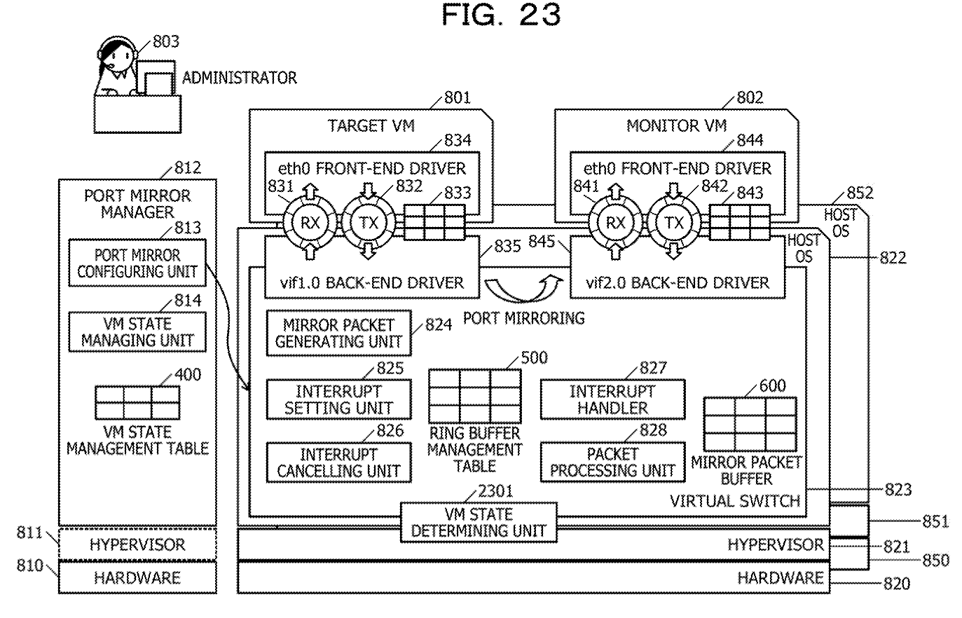

This allows the detecting unit 701 to detect that the present state is the state in which the monitor VM 102 is in operation and a mirror packet is not lost when the mirror packet is transmitted to the monitor VM 102. For example, in the port mirroring system 200, the operation of the detecting unit 701 is implemented by an interrupt setting unit and an interrupt cancelling unit to be described later with FIG. 8 or a VM state determining unit to be described later with FIG. 23 or the like.

The saving unit 702 accumulates packets that become targets of input and output regarding the first virtual machine in the period from detection of the suspended state to release of the suspended state in the save buffer 160 different from the input-output buffer 170. For example, the saving unit 702 moves packets once registered in the input-output buffer 170 to the save buffer 160 before the virtual switch 140 reads out and forwards the packets or before the target VM 101 reads out the packets, and deletes the packets from the input-output buffer 170.

If the mirror packet control device 100 is set to the state in which packets to be input from the virtual switch 140 to the first virtual machine are not replicated, the saving unit 702 may suspend the first virtual machine in response to detection of the suspended state of the second virtual machine. For example, the saving unit 702 determines the setting about which packets of packets to be input and packets to be output regarding the target VM 101 are to be replicated and be transmitted to the monitor VM 102. Furthermore, if the determined setting is setting in which packets to be input regarding the target VM 101 may not be replicated, the saving unit 702 suspends the target VM 101 in the period from the detection of the suspended state to the release of the suspended state.

In this case, the saving unit 702 does not accumulate, in the save buffer 160, the packets that become targets of input and output regarding the first virtual machine in the period from the detection of the suspended state to the release of the suspended state. For example, the saving unit 702 does not accumulate packets that become targets of input and output regarding the target VM 101 in the save buffer 160 but registers the packets in the input-output buffer 170.

Due to this, while the monitor VM 102 is in the suspended state, the saving unit 702 may suppress input and output of packets to and from the target VM 101 and suppress transmission of mirror packets to the monitor VM 102. For example, in the port mirroring system 200, the operation of the saving unit 702 is implemented by an interrupt handler to be described later with FIG. 8 or the like.

When the suspended state is released, the registering unit 703 registers packets accumulated in the save buffer 160 in the input-output buffer 170. For example, in the order in which the packets are accumulated in the save buffer 160, the registering unit 703 registers the packets accumulated in the save buffer 160 in the input-output buffer 170.

This allows the registering unit 703 to resume input and output of packets to and from the target VM 101 and also resume transmission of mirror packets to the monitor VM 102 in response to the resumption of input and output of packets to and from the target VM 101. Furthermore, the registering unit 703 allows packets to be input and output to and from the target VM 101 without changing the order of the input and output. For example, in the port mirroring system 200, the operation of the registering unit 703 is implemented by a packet processing unit to be described later with FIG. 8 or the like.

The output unit 704 carries out input and output of packets registered in the input-output buffer 170 to and from the first virtual machine and outputs mirror packets obtained by replicating the packets registered in the input-output buffer 170 to the second virtual machine. For example, the output unit 704 carries out input and output of packets reregistered in the input-output buffer 170 to and from the target VM 101. Furthermore, the output unit 704 transmits mirror packets obtained by replicating the packets reregistered in the input-output buffer 170 to the monitor VM 102.

This allows the output unit 704 to carry out input and output of packets reregistered in the input-output buffer 170 to and from the target VM 101 after the suspended state of the monitor VM 102 is released. Furthermore, in response to the input and output of the packets reregistered in the input-output buffer 170, the output unit 704 may transmit mirror packets obtained by replicating the packets reregistered in the input-output buffer 170 to the monitor VM 102 in which the suspended state has been released. For example, in the port mirroring system 200, the operation of the output unit 704 is implemented by a mirror packet generating unit to be described later with FIG. 8 or the like.

(Module Configuration Example of Port Mirroring System 200)

Next, a module configuration example of the port mirroring system 200 for implementing the operation of the respective functional units illustrated in FIG. 7 will be described by using FIG. 8.

FIG. 8 is an explanatory diagram illustrating a module configuration example of the port mirroring system 200. In the example of FIG. 8, a hypervisor 811 of the management device 201 is executed in hardware 810 of the management device 201. In the hypervisor 811 of the management device 201, a port mirror manager 812 is executed. The port mirror manager 812 includes a port mirror configuring unit 813 and a VM state managing unit 814. The port mirror manager 812 includes the VM state management table 400. Furthermore, the hypervisor 811 of the management device 201 may be absent.

The port mirror configuring unit 813 makes setting about which packets of packets to be input and packets to be output regarding a target VM 801 are to be replicated and be transmitted to a monitor VM 802, and manages the port mirroring. The VM state managing unit 814 monitors whether or not VMs in the respective mirror packet control devices 100 are in the suspended state and manages the state of the VMs in the respective mirror packet control devices 100.

Furthermore, in hardware 820 of a mirror packet control device 100-1, a hypervisor 821 of the mirror packet control device 100-1 is executed. In the hypervisor 821 of the mirror packet control device 100-1, a host OS 822 of the mirror packet control device 100-1 is executed. In the host OS 822 of the mirror packet control device 100-1, the target VM 801 and the monitor VM 802 are executed.

The host OS 822 of the mirror packet control device 100-1 includes a back-end driver 835 that controls access to an input ring buffer 831, an output ring buffer 832, and a packet buffer 833 that exist in a storage area possessed by the hypervisor 821. The input ring buffer 831 is used in storing an input notification about a packet to be input to the target VM 801. The output ring buffer 832 is used in storing an output notification about a packet to be output from the target VM 801. The packet buffer 833 is used in storing a packet to be input or output to or from the target VM 801.

The host OS 822 of the mirror packet control device 100-1 includes a back-end driver 845 that controls access to an input ring buffer 841, an output ring buffer 842, and a packet buffer 843 that exist in a storage area possessed by the hypervisor 821. The input ring buffer 841 is used in storing an input notification about a packet to be input to the monitor VM 802. The output ring buffer 842 is used in storing an output notification about a packet to be output from the monitor VM 802. The packet buffer 843 is used in storing a packet to be input or output to or from the monitor VM 802.

The target VM 801 includes a front-end driver 834 that controls access to the input ring buffer 831, the output ring buffer 832, and the packet buffer 833 that exist in the storage area possessed by the hypervisor 821. The monitor VM 802 includes a front-end driver 844 that controls access to the input ring buffer 841, the output ring buffer 842, and the packet buffer 843 that exist in the storage area possessed by the hypervisor 821.

The host OS 822 of the mirror packet control device 100-1 includes a virtual switch 823. The virtual switch 823 includes a mirror packet generating unit 824, an interrupt setting unit 825, an interrupt cancelling unit 826, an interrupt handler 827, and a packet processing unit 828. The virtual switch 823 includes the ring buffer management table 500 and the mirror packet buffer 600.

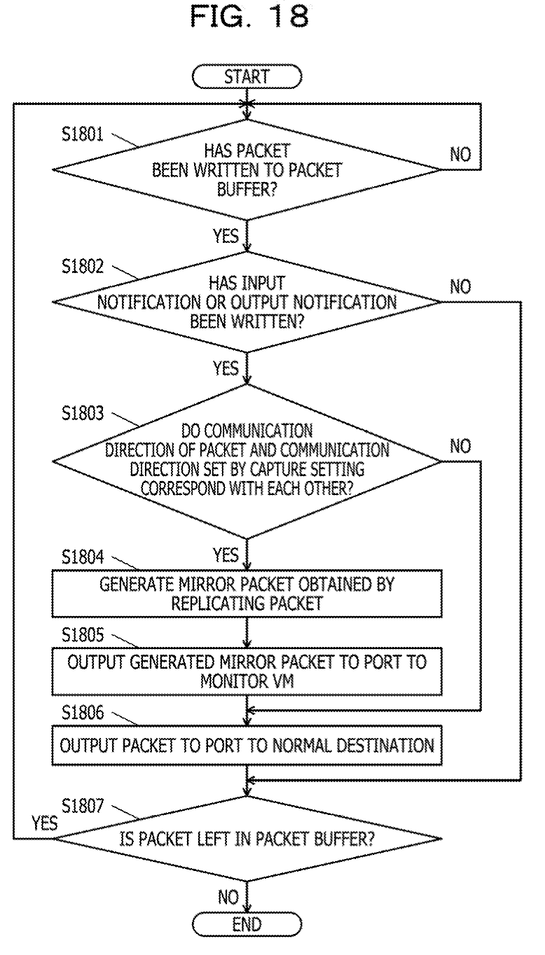

When a packet is written to the packet buffer 833 of the back-end driver 835, the mirror packet generating unit 824 outputs a mirror packet obtained by replicating the packet to a port to the monitor VM 802. Furthermore, the mirror packet generating unit 824 outputs the packet to a port to the normal destination. For example, the mirror packet generating unit 824 executes mirroring processing to be described later with FIG. 18.

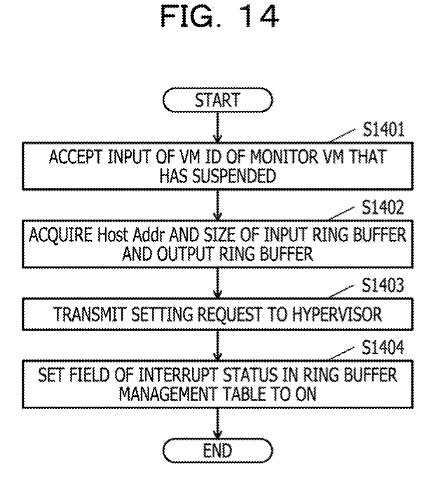

The interrupt setting unit 825 causes an interrupt to be generated when writing to the input ring buffer 831 or the output ring buffer 832 is carried out. For example, the interrupt setting unit 825 transmits a setting request to the hypervisor 821 to generate an interrupt when writing to the input ring buffer 831 or the output ring buffer 832 is carried out. For example, the interrupt setting unit 825 executes interrupt setting processing to be described later with FIG. 14.

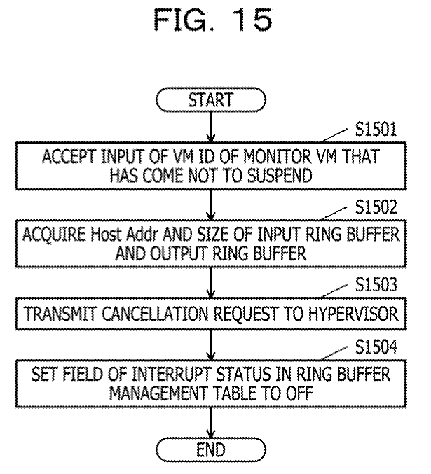

The interrupt cancelling unit 826 causes an interrupt to be kept from being generated even when writing to the input ring buffer 831 or the output ring buffer 832 is carried out. For example, the interrupt cancelling unit 826 transmits a cancellation request to the hypervisor 821 to keep an interrupt from being generated even when writing to the input ring buffer 831 or the output ring buffer 832 is carried out. For example, the interrupt cancelling unit 826 executes interrupt cancellation processing to be described later with FIG. 15.

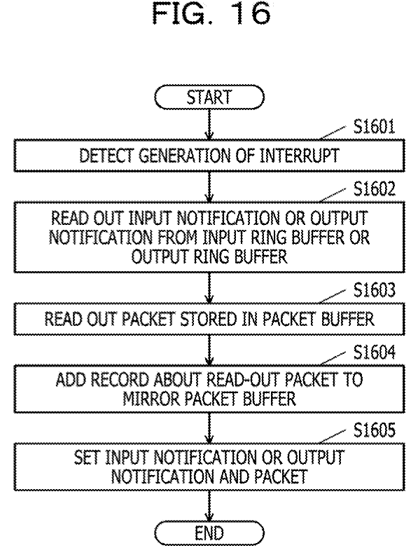

When an interrupt is generated, the interrupt handler 827 saves, to the mirror packet buffer 600, input notifications or output notifications stored in the input ring buffer 831 or the output ring buffer 832 and packets stored in the packet buffer 833. For example, the interrupt handler 827 executes interrupt processing to be described later with FIG. 16.

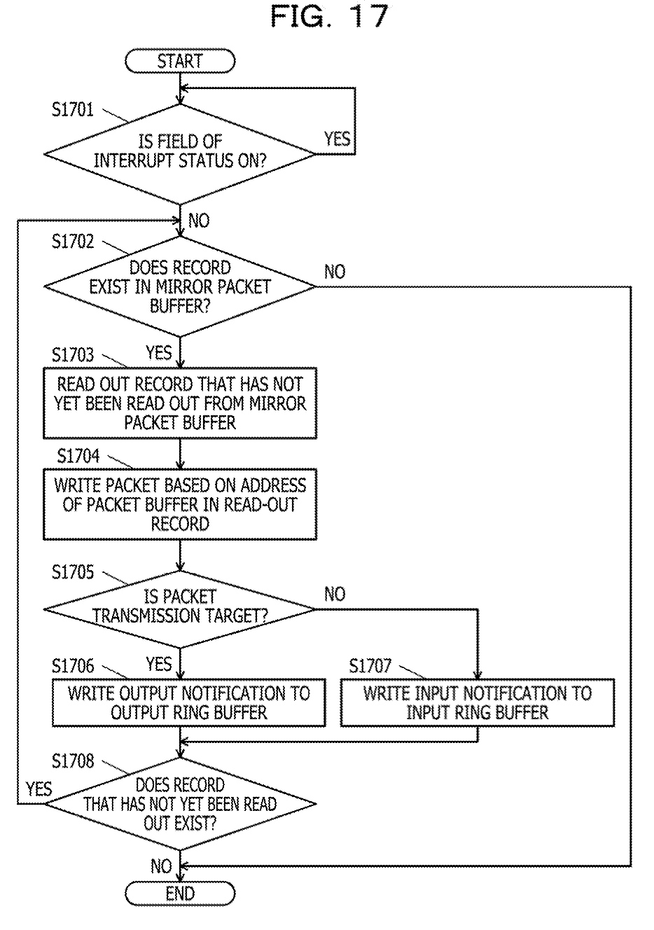

The packet processing unit 828 returns the input notifications or output notifications from the mirror packet buffer 600 to the input ring buffer 831 or the output ring buffer 832 and returns the packets to the packet buffer 833. For example, the packet processing unit 828 executes packet processing to be described later with FIG. 17.

Furthermore, in hardware 850 of a mirror packet control device 100-2, a hypervisor 851 of the mirror packet control device 100-2 is executed. In the hypervisor 851 of the mirror packet control device 100-2, a host OS 852 of the mirror packet control device 100-2 is executed. The host OS 852 of the mirror packet control device 100-2 serves as a live migration destination of the monitor VM 802 executed in the host OS 822 of the mirror packet control device 100-1. The host OS 852 of the mirror packet control device 100-2 includes the virtual switch 823.

(Operation Example 1 of Port Mirroring System 200)

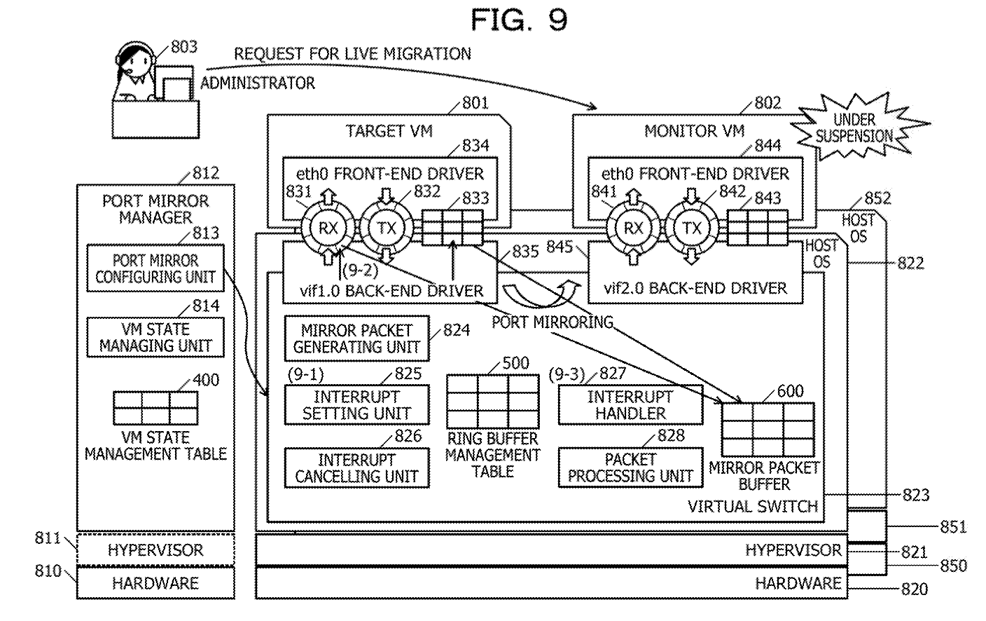

Next, operation example 1 of the port mirroring system 200 will be described by using FIG. 9 to FIG. 12.

FIG. 9 to FIG. 12 are explanatory diagrams illustrating operation example 1 of the port mirroring system 200. Suppose that, in FIG. 9, the monitor VM 802 starts live migration based on operation input by an administrator 803.

(9-1) When detecting that the monitor VM 802 has started live migration, the interrupt setting unit 825 determines that the monitor VM 802 has become the suspended state. When determining that the monitor VM 802 has become the suspended state, the interrupt setting unit 825 sets the interrupt status to ON and makes setting to cause the hypervisor 821 to generate an interrupt.

(9-2) The virtual switch 823 stores a packet that becomes an input target in the packet buffer 833 through the back-end driver 835, and stores an input notification including an address that indicates the storage area in which the packet is stored in the input ring buffer 831. The hypervisor 821 generates an interrupt because the input notification is stored in the input ring buffer 831.

(9-3) Because the monitor VM 802 is in the suspended state and the interrupt is generated, the interrupt handler 827 takes out the input notification stored in the input ring buffer 831 and deletes the input notification from the input ring buffer 831. Furthermore, the interrupt handler 827 takes out the packet stored in the packet buffer 833 based on the address included in the input notification and deletes the packet from the packet buffer 833. The interrupt handler 827 associates the taken-out input notification with the taken-out packet and accumulates the input notification and the packet in the mirror packet buffer 600.

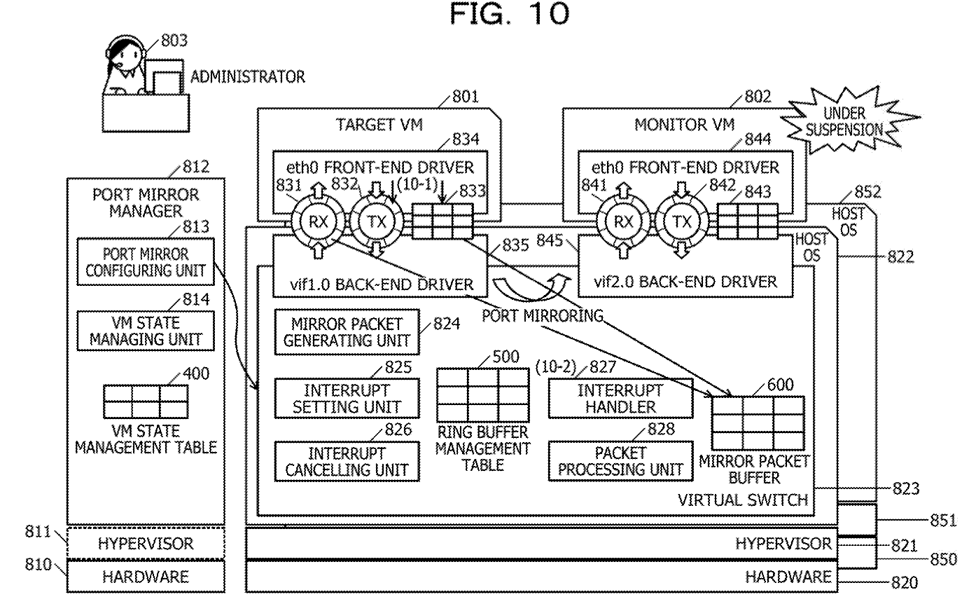

This allows the virtual switch 823 to move the packet once registered in the packet buffer 833 to the mirror packet buffer 600 before the target VM 801 reads out the packet and delete the packet from the packet buffer 833. As a result, the virtual switch 823 may temporarily suspend input of a packet to the target VM 801 and suppress transmission of a mirror packet to the monitor VM 802 in response to input of the packet to the target VM 801. Furthermore, the virtual switch 823 may also suppress transmission of a response from the target VM 801, and suspend transmission of a packet from the transmission source of the packet to the target VM 801 for a certain time by making the transmission source of the packet wait for the response. Here, transition is made to description with FIG. 10.

In FIG. 10, (10-1) the target VM 801 stores a packet that becomes an output target in the packet buffer 833 through the front-end driver 834. Furthermore, the target VM 801 stores an output notification including an address that indicates the storage area in which the packet is stored in the output ring buffer 832 through the front-end driver 834. The hypervisor 821 generates an interrupt because the output notification is stored in the output ring buffer 832.

(10-2) Because the monitor VM 802 is in the suspended state and the interrupt is generated, the interrupt handler 827 of the virtual switch 823 takes out the output notification stored in the output ring buffer 832 and deletes the output notification from the output ring buffer 832. Furthermore, the interrupt handler 827 of the virtual switch 823 takes out the packet stored in the packet buffer 833 based on the address included in the output notification and deletes the packet from the packet buffer 833. The interrupt handler 827 of the virtual switch 823 associates the taken-out output notification with the taken-out packet and accumulates the output notification and the packet in the mirror packet buffer 600.

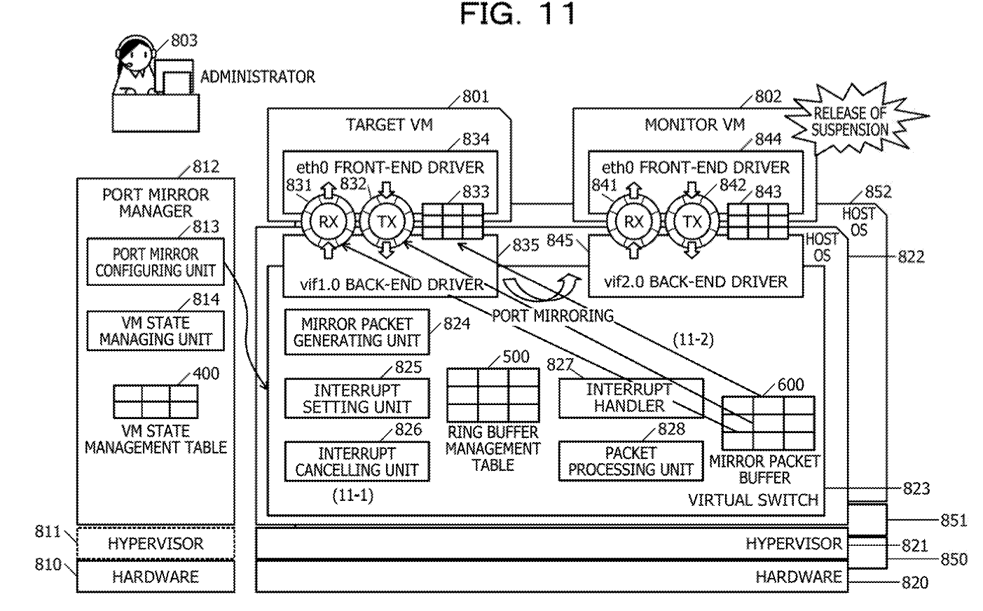

This allows the virtual switch 823 to move the packet once registered in the packet buffer 833 to the mirror packet buffer 600 before the virtual switch 823 reads out and forwards the packet and delete the packet from the packet buffer 833. As a result, the virtual switch 823 may temporarily suspend output of a packet from the target VM 801 and suppress transmission of a mirror packet to the monitor VM 802 in response to output of the packet from the target VM 801. Here, transition is made to description with FIG. 11.

Suppose that, in FIG. 11, the monitor VM 802 ends the live migration and the suspended state is released. (11-1) When detecting that the live migration of the monitor VM 802 has ended, the interrupt cancelling unit 826 determines that the suspended state of the monitor VM 802 has been released. When determining that the suspended state of the monitor VM 802 has been released, the interrupt cancelling unit 826 sets the interrupt status to OFF and makes setting to keep the hypervisor 821 from generating an interrupt.

(11-2) The packet processing unit 828 takes out the input notification accumulated in the mirror packet buffer 600 and returns the input notification to the input ring buffer 831 through the back-end driver 835. Furthermore, the packet processing unit 828 returns the packet corresponding to the input notification accumulated in the mirror packet buffer 600 to the packet buffer 833 through the back-end driver 835.

Furthermore, the packet processing unit 828 takes out the output notification accumulated in the mirror packet buffer 600 and returns the output notification to the output ring buffer 832 through the back-end driver 835. Furthermore, the packet processing unit 828 returns the packet corresponding to the output notification accumulated in the mirror packet buffer 600 to the packet buffer 833 through the back-end driver 835.

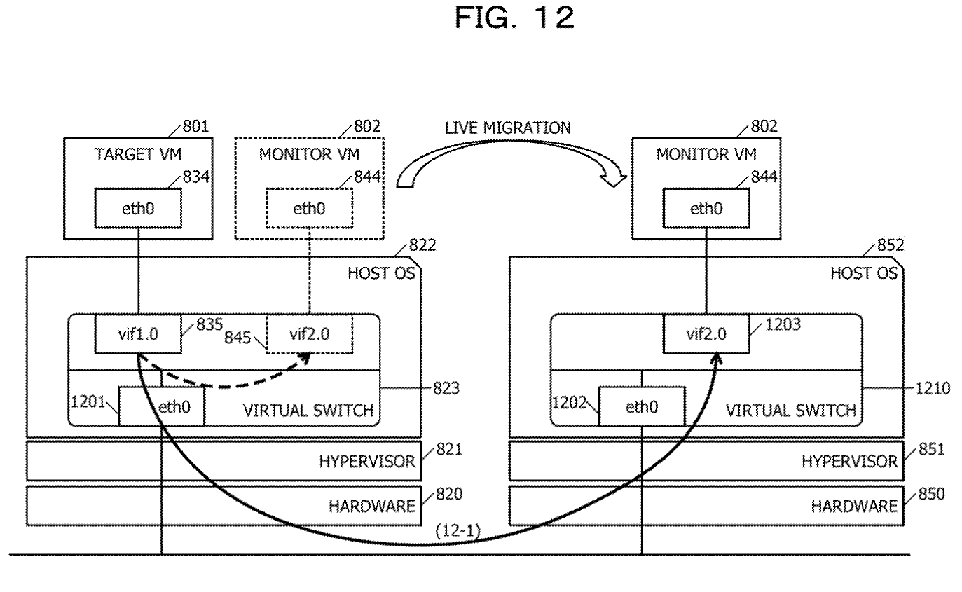

This allows the virtual switch 823 to resume registration of input notifications in the input ring buffer 831 and registration of output notifications in the output ring buffer 832 and resume input and output of packets to and from the target VM 801. Here, transition is made to description with FIG. 12.

In FIG. 12, (12-1) in response to input or output of a packet about the target VM 801, the mirror packet generating unit 824 generates a mirror packet obtained by replicating the packet that is input or output. Then, the mirror packet generating unit 824 transmits the generated mirror packet to the monitor VM 802 that is moved to the host OS 852 and is in execution in the host OS 852 and in which the suspended state has been released.

For example, in response to input or output of a packet about the target VM 801, the mirror packet generating unit 824 outputs a mirror packet to a port 1201 that is given a name eth0 and leads to the mirror packet control device 100-2. Meanwhile, to a virtual switch 1210 of the mirror packet control device 100-2, the mirror packet is input from a port 1202 that is given the name eth0 and leads to the mirror packet control device 100-1.

The virtual switch 1210 of the mirror packet control device 100-2 outputs the mirror packet from a port 1203 that is given a name vif2.0 and leads to the monitor VM 802 that is moved to the host OS 852 and is in execution in the host OS 852 and in which the suspended state has been released. This allows the virtual switch 823 to resume the port mirroring.

(One Example of State Management Processing Procedure)

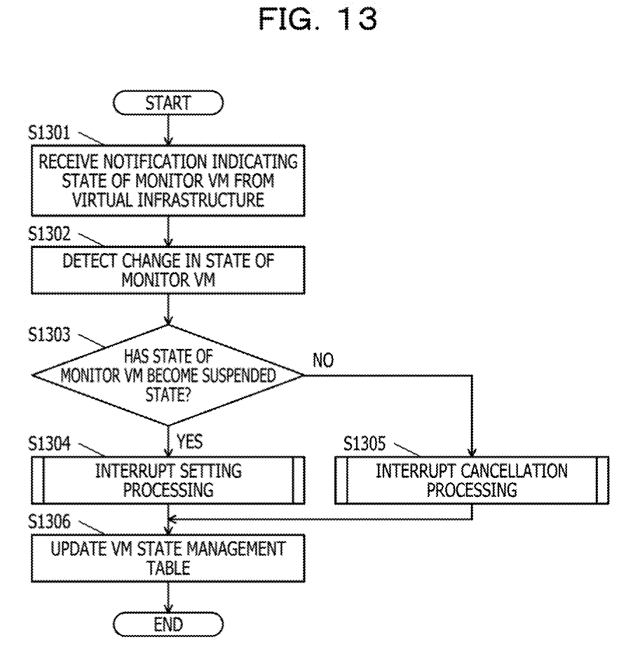

Next, one example of a state management processing procedure carried out by the VM state managing unit 814 will be described by using FIG. 13.

FIG. 13 is a flowchart illustrating the one example of the state management processing procedure. In FIG. 13, the VM state managing unit 814 receives a notification indicating the state of the monitor VM 802 from a virtual infrastructure (step S1301). Next, based on the received notification, the VM state managing unit 814 refers to the VM state management table 400 and detects change in the state of the monitor VM 802 (step S1302).

Then, the VM state managing unit 814 determines whether or not the state of the monitor VM 802 has become the suspended state (step S1303). If the state has become the suspended state (step S1303: Yes), the VM state managing unit 814 makes transition to processing of a step S1304. In the step S1304, the VM state managing unit 814 outputs the VM ID of the monitor VM 802 that has suspended to the interrupt setting unit 825 and causes the interrupt setting unit 825 to execute the interrupt setting processing to be described later with FIG. 14 (step S1304). Then, the VM state managing unit 814 makes transition to processing of a step S1306.

On the other hand, if the state has come not to be the suspended state (step S1303: No), the VM state managing unit 814 makes transition to processing of a step S1305. In the step S1305, the VM state managing unit 814 outputs the VM ID of the monitor VM 802 that has come not to suspend to the interrupt cancelling unit 826 and causes the interrupt cancelling unit 826 to execute the interrupt cancellation processing to be described later with FIG. 15 (step S1305). Then, the VM state managing unit 814 makes transition to the processing of the step S1306. In the step S1306, the VM state managing unit 814 updates the VM state management table 400 (step S1306) and ends the state management processing. This procedure allows the VM state managing unit 814 to manage the state of the monitor VM 802 in the mirror packet control device 100.

(One Example of Interrupt Setting Processing Procedure)

Next, one example of an interrupt setting processing procedure carried out by the interrupt setting unit 825 will be described by using FIG. 14.

FIG. 14 is a flowchart illustrating the one example of the interrupt setting processing procedure. In FIG. 14, the interrupt setting unit 825 accepts input of the VM ID of the monitor VM 802 that has suspended (step S1401). Next, the interrupt setting unit 825 refers to the ring buffer management table 500 and acquires Host Addr and size of the input ring buffer 831 and the output ring buffer 832 (step S1402). Then, the interrupt setting unit 825 transmits a setting request to the hypervisor 821 to generate an interrupt when writing to the input ring buffer 831 or the output ring buffer 832 is carried out (step S1403).

Next, the interrupt setting unit 825 sets the field of the interrupt status in the ring buffer management table 500 to ON (step S1404). Then, the interrupt setting unit 825 ends the interrupt setting processing. This procedure allows the interrupt setting unit 825 to cause an interrupt to be generated before the target VM 801 reads out the packet once registered in the packet buffer 833 or before the virtual switch 823 reads out and forwards the packet.

(One Example of Interrupt Cancellation Processing Procedure)

Next, one example of an interrupt cancellation processing procedure carried out by the interrupt cancelling unit 826 will be described by using FIG. 15.

FIG. 15 is a flowchart illustrating the one example of the interrupt cancellation processing procedure. In FIG. 15, the interrupt cancelling unit 826 accepts input of the VM ID of the monitor VM 802 that has come not to suspend (step S1501). Next, the interrupt cancelling unit 826 refers to the ring buffer management table 500 and acquires Host Addr and size of the input ring buffer 831 and the output ring buffer 832 (step S1502). Then, the interrupt cancelling unit 826 transmits a cancellation request to the hypervisor 821 to keep an interrupt from being generated even when writing to the input ring buffer 831 or the output ring buffer 832 is carried out (step S1503).

Next, the interrupt cancelling unit 826 sets the field of the interrupt status in the ring buffer management table 500 to OFF (step S1504). Then, the interrupt cancelling unit 826 ends the interrupt cancellation processing. This procedure allows the interrupt cancelling unit 826 to keep an interrupt from being generated and suppress the lowering of the performance of the virtual switch 823.

(One Example of Interrupt Processing Procedure)

Next, one example of an interrupt processing procedure carried out by the interrupt handler 827 will be described by using FIG. 16.

FIG. 16 is a flowchart illustrating the one example of the interrupt processing procedure. In FIG. 16, the interrupt handler 827 detects generation of an interrupt (step S1601). Next, the interrupt handler 827 reads out an input notification or an output notification from the input ring buffer 831 or the output ring buffer 832 (step S1602). Then, the interrupt handler 827 reads out the address and size of a packet from the read-out input notification or output notification and reads out the packet stored in the packet buffer 833 (step S1603).

Next, the interrupt handler 827 adds a record about the read-out packet to the mirror packet buffer 600 (step S1604). Then, the interrupt handler 827 sets the read-out input notification or output notification and the read-out packet in the added record (step S1605). Thereafter, the interrupt handler 827 ends the interrupt processing. This procedure allows the interrupt handler 827 to suppress input and output of packets about the target VM 801 and suppress transmission of mirror packets to the monitor VM 802 while the monitor VM 802 is in the suspended state.

(One Example of Packet Processing Procedure)

Next, one example of a packet processing procedure carried out by the packet processing unit 828 will be described by using FIG. 17.

FIG. 17 is a flowchart illustrating the one example of the packet processing procedure. In FIG. 17, the packet processing unit 828 determines whether or not the field of the interrupt status in the ring buffer management table 500 is ON (step S1701). If the field is ON (step S1701: Yes), the packet processing unit 828 returns to the processing of the step S1701.

On the other hand, if the field is not ON (step S1701: No), the packet processing unit 828 determines whether or not a record exists in the mirror packet buffer 600 (step S1702). If a record does not exist (step S1702: No), the packet processing unit 828 ends the packet processing.

On the other hand, if a record exists (step S1702: Yes), the packet processing unit 828 reads out a record that has not yet been read out from the mirror packet buffer 600 (step S1703). At this time, the packet processing unit 828 may refer to the field of the serial number in the mirror packet buffer 600 and read out the record in the order of storing in the mirror packet buffer 600.

Next, the packet processing unit 828 writes a packet to the packet buffer 833 based on the address of the packet buffer 833 in the read-out record (step S1704). Then, the packet processing unit 828 determines whether or not the packet is a transmission target (step S1705). If the packet is a transmission target (step S1705: Yes), the packet processing unit 828 writes an output notification to the output ring buffer 832 (step S1706) and makes transition to processing of a step S1708.

On the other hand, if the packet is not a transmission target (step S1705: No), the packet processing unit 828 writes an input notification to the input ring buffer 831 (step S1707) and makes transition to the processing of the step S1708. In the step S1708, the packet processing unit 828 determines whether or not a record that has not yet been read out exists in the mirror packet buffer 600 (step S1708).

If a record that has not yet been read out exists (step S1708: Yes), the packet processing unit 828 returns to the processing of the step S1702. On the other hand, if a record that has not been read out does not exist (step S1708: No), the packet processing unit 828 ends the packet processing. This procedure allows the packet processing unit 828 to resume input and output of packets to and from the target VM 801 and also resume transmission of mirror packets to the monitor VM 802 in response to the resumption of input and output of packets to and from the target VM 801.

(One Example of Mirroring Processing Procedure)

Next, one example of a mirroring processing procedure carried out by the mirror packet generating unit 824 will be described by using FIG. 18.

FIG. 18 is a flowchart illustrating the one example of the mirroring processing procedure. In FIG. 18, the mirror packet generating unit 824 determines whether or not a packet has been written to the packet buffer 833 (step S1801). If a packet has not been written (step S1801: No), the mirror packet generating unit 824 returns to the processing of the step S1801.

On the other hand, if a packet has been written (step S1801: Yes), the mirror packet generating unit 824 determines whether or not an input notification or an output notification has been written to the input ring buffer 831 or the output ring buffer 832 (step S1802). If a notification has not been written (step S1802: No), the mirror packet generating unit 824 makes transition to processing of a step S1807.

On the other hand, if a notification has been written (step S1802: Yes), the mirror packet generating unit 824 determines whether or not the communication direction of the packet and the communication direction set by capture setting correspond with each other (step S1803). If the communication directions do not correspond with each other (step S1803: No), the mirror packet generating unit 824 makes transition to processing of a step S1806.

On the other hand, if the communication directions correspond with each other (step S1803: Yes), the mirror packet generating unit 824 generates a mirror packet obtained by replicating the packet (step S1804). Next, the mirror packet generating unit 824 outputs the generated mirror packet to a port to the monitor VM 802 (step S1805). Then, the mirror packet generating unit 824 outputs the packet to a port to the normal destination (step S1806).

Next, the mirror packet generating unit 824 determines whether or not a packet is left in the packet buffer 833 (step S1807). If a packet is left (step S1807: Yes), the mirror packet generating unit 824 returns to the processing of the step S1801.

On the other hand, if a packet is not left (step S1807: No), the mirror packet generating unit 824 ends the mirroring processing. This procedure allows the mirror packet generating unit 824 to carry out input and output of packets stored in the packet buffer 833 regarding the target VM 801. Furthermore, the mirror packet generating unit 824 may transmit mirror packets obtained by replicating the packets stored in the packet buffer 833 to the monitor VM 802.

(One Example of Flow of Operation When Monitor VM 802 Suspends)

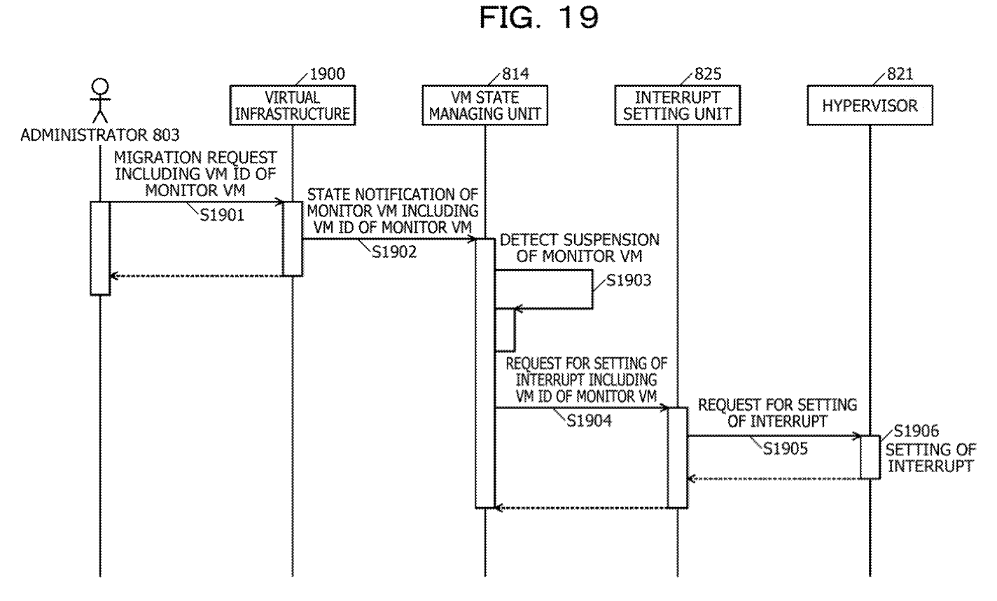

Next, one example of the flow of operation when the monitor VM 802 suspends in the port mirroring system 200 will be described by using FIG. 19.

FIG. 19 is a sequence diagram illustrating the one example of the flow of operation when the monitor VM 802 suspends. In FIG. 19, the administrator 803 inputs a live migration request including the VM ID of the monitor VM 802 to a virtual infrastructure 1900 (step S1901). When accepting the input of the live migration request, the virtual infrastructure 1900 inputs a state notification of the monitor VM 802 including the VM ID of the monitor VM 802 to the VM state managing unit 814 (step S1902).

The VM state managing unit 814 detects the suspension of the monitor VM 802 (step S1903). When detecting the suspension of the monitor VM 802, the VM state managing unit 814 outputs a request for setting of interrupt including the VM ID of the monitor VM 802 to the interrupt setting unit 825 (step S1904).

When accepting the input of the request for setting of interrupt, the interrupt setting unit 825 inputs the request for setting of interrupt to the hypervisor 821 (step S1905). When accepting the input of the request for setting of interrupt, the hypervisor 821 carries out setting of interrupt (step S1906). This allows the mirror packet control device 100 to reduce the probability of loss of mirror packets.

(One Example of Flow of Operation When Suspension of Monitor VM 802 is Released)

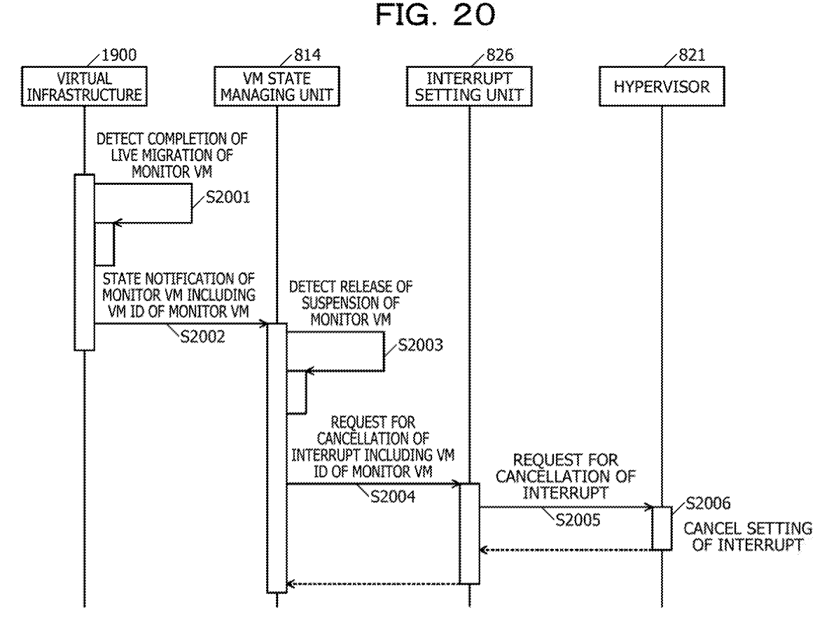

Next, one example of the flow of operation when the suspension of the monitor VM 802 is released in the port mirroring system 200 will be described by using FIG. 20.

FIG. 20 is a sequence diagram illustrating the one example of the flow of operation when the suspension of the monitor VM 802 is released. In FIG. 20, the virtual infrastructure 1900 detects the completion of live migration of the monitor VM 802 (step S2001). When detecting the completion of live migration of the monitor VM 802, the virtual infrastructure 1900 inputs a state notification of the monitor VM 802 including the VM ID of the monitor VM 802 to the VM state managing unit 814 (step S2002).

The VM state managing unit 814 detects release of the suspension of the monitor VM 802 (step S2003). When detecting release of the suspension of the monitor VM 802, the VM state managing unit 814 outputs a request for cancellation of interrupt including the VM ID of the monitor VM 802 to the interrupt cancelling unit 826 (step S2004).

When accepting the input of the request for cancellation of interrupt, the interrupt cancelling unit 826 inputs the request for cancellation of interrupt to the hypervisor 821 (step S2005). When accepting the input of the request for cancellation of interrupt, the hypervisor 821 cancels setting of interrupt (step S2006). This allows the mirror packet control device 100 to resume the port mirroring.

(Operation Example 2 of Port Mirroring System 200)

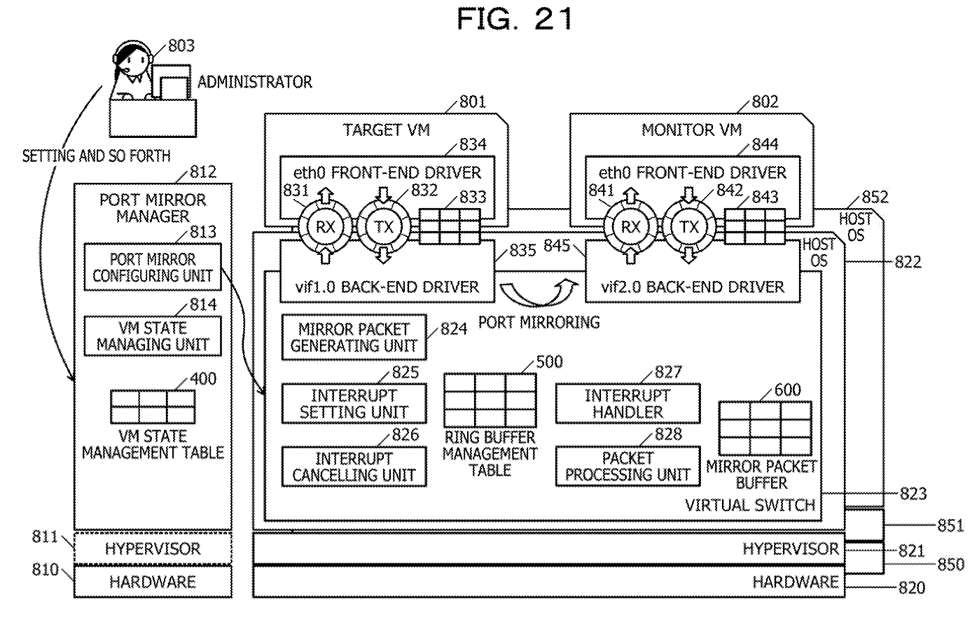

Next, operation example 2 of the port mirroring system 200 will be described by using FIG. 21. In operation example 1, description has been made about the case in which the virtual switch 823 replicates both packets to be input to the target VM 801 and packets to be output from the target VM 801 and transmits mirror packets obtained by the replication to the monitor VM 802.

In contrast, in operation example 2, description will be made about the case in which the virtual switch 823 carries out operation different between the case in which packets to be input to the target VM 801 may not be replicated and the case in which packets to be input to the target VM 801 are replicated.

FIG. 21 is an explanatory diagram illustrating operation example 2 of the port mirroring system 200. In FIG. 21, the port mirror manager 812 further includes a determining unit 2101. The determining unit 2101 acquires a communication direction set by capture setting by the administrator 803. The capture setting is setting of the communication direction of a packet deemed as a target of generation of a mirror packet.

For example, the determining unit 2101 suspends the target VM 801 if the communication direction set by the capture setting is “transmission,” which indicates the direction of output from the target VM 801. On the other hand, for example, the determining unit 2101 causes the virtual switch 823 to execute processing similarly to operation example 1 if the communication direction set by the capture setting is “reception,” which indicates the direction of input to the target VM 801. Similarly, for example, the determining unit 2101 causes the virtual switch 823 to execute processing similarly to operation example 1 if the communication direction set by the capture setting is “transmission or reception,” which indicates the direction of input or output to or from the target VM 801.

This allows the management device 201 to suspend the target VM 801 and suppress transmission of packets from the target VM 801 while the monitor VM 802 is carrying out live migration. For this reason, the management device 201 may suppress transmission of mirror packets obtained by replicating packets to be transmitted from the target VM 801 to the monitor VM 802 under suspension and suppress the occurrence of the situation in which the mirror packets are not received by the monitor VM 802 and are lost.

(One Example of Determination Processing Procedure)

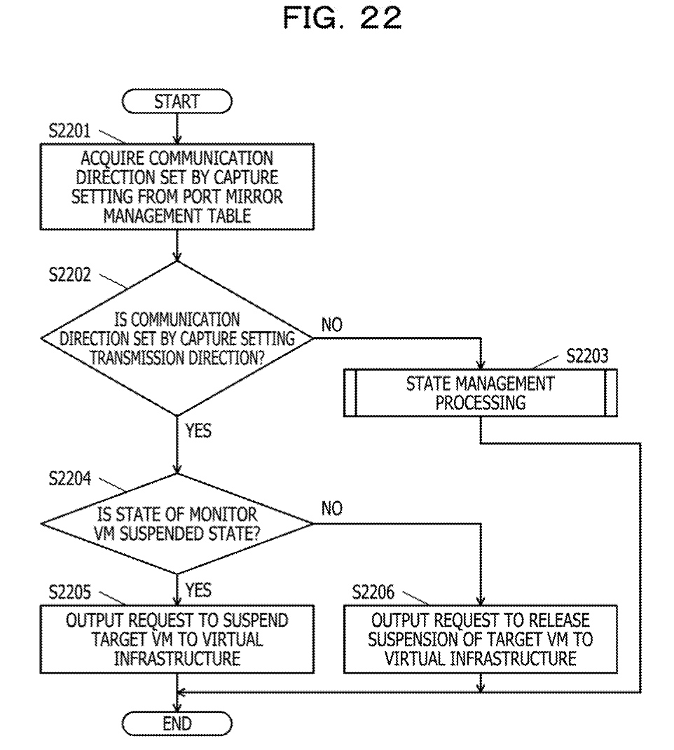

Next, one example of a determination processing procedure carried out by the determining unit 2101 will be described by using FIG. 22.

FIG. 22 is a flowchart illustrating the one example of the determination processing procedure. In FIG. 22, the determining unit 2101 acquires a communication direction set by capture setting by the administrator 803 (step S2201). Next, the determining unit 2101 determines whether or not the communication direction set by the capture setting is the transmission direction (step S2202). If the communication direction is not the transmission direction (step S2202: No), the determining unit 2101 causes the VM state managing unit 814 to execute the state management processing (step S2203), and ends the determination processing.

On the other hand, if the communication direction is the transmission direction (step S2202: Yes), the determining unit 2101 determines whether or not the state of the monitor VM 802 is the suspended state (step S2204). If the state is the suspended state (step S2204: Yes), the determining unit 2101 outputs a request to suspend the target VM 801 to the virtual infrastructure 1900 (step S2205), and ends the determination processing.

On the other hand, if the state is not the suspended state (step S2204: No), the determining unit 2101 outputs a request to release the suspension of the target VM 801 to the virtual infrastructure 1900 (step S2206), and ends the determination processing. This procedure allows the determining unit 2101 to suspend the target VM 801 and reduce the probability of loss of mirror packets.

(Operation Example 3 of Port Mirroring System 200)

Next, operation example 3 of the port mirroring system 200 will be described by using FIG. 23. In operation example 1, description has been made about the case in which the virtual switch 823 determines that the monitor VM 802 has become the suspended state in response to the start of live migration by the monitor VM 802.

In contrast, in operation example 3, description will be made about the case in which the virtual switch 823 monitors the amount of transfer in a network regarding the monitor VM 802 and determines that the monitor VM 802 has become the suspended state in response to falling of the amount of transfer in the network below a threshold.

FIG. 23 is an explanatory diagram illustrating operation example 3 of the port mirroring system 200. In FIG. 23, the host OS 822 further includes a VM state determining unit 2301. The VM state determining unit 2301 monitors the amount of transfer in the network about the monitor VM 802. Furthermore, if the amount of transfer in the network falls below the threshold, the VM state determining unit 2301 determines that the monitor VM 802 is in the suspended state, and issues a notification to the interrupt setting unit 825. The interrupt setting unit 825 executes similar processing as operation example 1 if it is determined that the monitor VM 802 is in the suspended state by the VM state determining unit 2301, and therefore description is omitted.

Thereafter, the VM state determining unit 2301 monitors a gratuitous address resolution protocol (GARP) about the monitor VM 802. Furthermore, if the GARP is detected, the VM state determining unit 2301 determines that the suspended state of the monitor VM 802 has been released, and issues a notification to the interrupt cancelling unit 826. The interrupt cancelling unit 826 executes similar processing as operation example 1 if it is determined that the suspended state of the monitor VM 802 has been released by the VM state determining unit 2301, and therefore description is omitted.

This configuration allows the virtual switch 823 to determine the period in which the monitor VM 802 is in the suspended state with high accuracy. As a result, the virtual switch 823 may suppress the occurrence of the situation in which the period in which input and output of packets about the target VM 801 are not carried out also becomes long according to the state in which the period in which the monitor VM 802 is determined to be the suspended state becomes long.

(One Example of State Determination Processing Procedure)

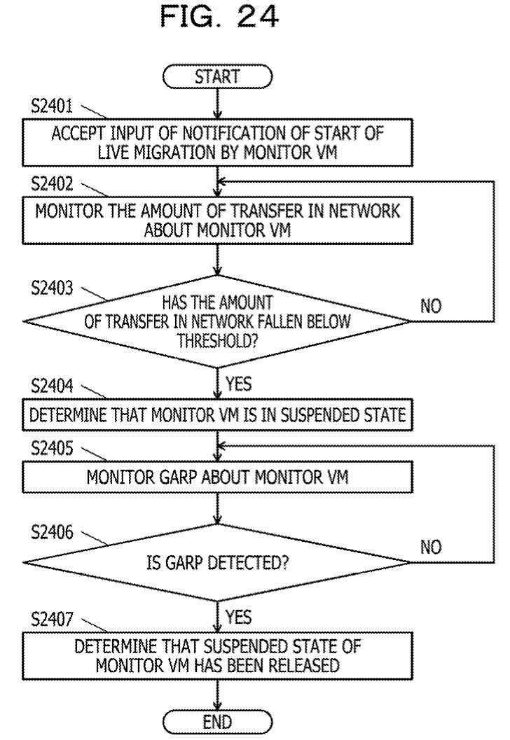

Next, one example of a state determination processing procedure carried out by the VM state determining unit 2301 will be described by using FIG. 24.

FIG. 24 is a flowchart illustrating the one example of the state determination processing procedure. In FIG. 24, the VM state determining unit 2301 accepts input of a notification of start of live migration by the monitor VM 802 (step S2401). Next, the VM state determining unit 2301 monitors the amount of transfer in the network about the monitor VM 802 (step S2402).

Then, the VM state determining unit 2301 determines whether or not the amount of transfer in the network has fallen below the threshold (step S2403). If the amount of transfer is equal to or larger than the threshold (step S2403: No), the VM state determining unit 2301 returns to the processing of the step S2402.

On the other hand, if the amount of transfer has fallen below the threshold (step S2403: Yes), the VM state determining unit 2301 determines that the monitor VM 802 is in the suspended state (step S2404). Next, the VM state determining unit 2301 monitors the GARP about the monitor VM 802 (step S2405).

Then, the VM state determining unit 2301 determines whether or not the GARP is detected (step S2406). If the GARP is not detected (step S2406: No), the VM state determining unit 2301 returns to the processing of the step S2405.

On the other hand, if the GARP is detected (step S2406: Yes), the VM state determining unit 2301 determines that the suspended state of the monitor VM 802 has been released (step S2407). Then, the VM state determining unit 2301 ends the state determination processing. This procedure allows the VM state determining unit 2301 to identify the period in which the monitor VM 802 is in the suspended state with high accuracy.

As described above, according to the mirror packet control device 100, the suspended state of the monitor VM 802 coupled to the virtual switch 823 may be detected. Furthermore, according to the mirror packet control device 100, packets that become targets of input and output regarding the target VM 801 in the period from detection of the suspended state to release of the suspended state may be accumulated in the save buffer. Moreover, according to the mirror packet control device 100, when the suspended state is released, the packets accumulated in the save buffer may be registered in the input-output buffer used for input and output regarding the target VM 801 coupled to the virtual switch 823. Due to this, while the monitor VM 802 is in the suspended state, the mirror packet control device 100 may suppress input and output of packets to and from the target VM 801 and suppress transmission of mirror packets to the monitor VM 802.

Furthermore, according to the mirror packet control device 100, input and output to and from the target VM 801 may be carried out regarding packets registered in the input-output buffer and mirror packets obtained by replicating the packets registered in the input-output buffer may be output to the monitor VM 802. This allows the mirror packet control device 100 to resume the port mirroring.

Moreover, according to the mirror packet control device 100, packets accumulated in the save buffer may be registered in the input-output buffer in the order in which the packets are accumulated in the save buffer. Due to this, the mirror packet control device 100 may allow resumption of input and output of packets to and from the target VM 801 without changing the order of the input and output.

In addition, according to the mirror packet control device 100, the suspended state of the monitor VM 802 may be detected in response to the start of live migration by the monitor VM 802 from an arithmetic device in operation to another arithmetic device. This allows the mirror packet control device 100 to identify the period in which the monitor VM 802 is under suspension.

Furthermore, according to the mirror packet control device 100, the suspended state of the monitor VM 802 may be detected in response to falling of the amount of transfer of information relating to the monitor VM 802 from an arithmetic device in operation to another arithmetic device below a threshold. This allows the mirror packet control device 100 to identify the period in which the monitor VM 802 is under suspension with high accuracy.

Moreover, according to the mirror packet control device 100, if the mirror packet control device 100 is set to the state in which packets to be input to the target VM 801 are not replicated, the target VM 801 may be suspended in response to detection of the suspended state of the monitor VM 802. Furthermore, in this case, according to the mirror packet control device 100, packets that become targets of input and output regarding the target VM 801 may be kept from being accumulated in the save buffer in the period from the detection of the suspended state to release of the suspended state. Due to this, while the monitor VM 802 is in the suspended state, the mirror packet control device 100 may suppress input and output of packets to and from the target VM 801 and suppress transmission of mirror packets to the monitor VM 802.

The mirror packet control method described in the present embodiment may be implemented by execution of a program prepared in advance by a computer such as a personal computer or a work station. The present mirror packet control program is recorded in a computer-readable recording medium such as hard disc, flexible disc, compact disc (CD)-ROM, magnetooptic disc (MO), or digital versatile disc (DVD) and is executed by being read out from the recording medium by a computer. Furthermore, the present mirror packet control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of controlling a first virtual machine and a second virtual machine, the method comprising:
detecting that the second virtual machine is in a suspended state;
storing one or more first packets into a first buffer during the suspended state;
inputting the one or more first packets stored in the first buffer into a second buffer after the suspended state is ended;
generating one or more second packets by replicating the one or more first packets input from the first buffer to the second buffer;
transmitting the one or more first packets stored in the second buffer to the first virtual machine; and
transmitting the second packet to the second virtual machine.

2. The method according to claim 1, wherein
when the one or more first packets include a plurality of packets, the storing includes storing the plurality of packets into the first buffer in first order, and
the inputting includes inputting the plurality of packets into the second buffer in the first order.

3. The method according to claim 1, wherein
the second virtual machine is implemented in a first information processing device, and
the detecting includes detecting a starting of live migration of the second virtual machine from the first information processing apparatus to a second information processing apparatus.

4. The method according to claim 1, wherein
the second virtual machine is implemented in a first information processing device, and
the detecting includes detecting, when the second virtual machine executes live migration from the first information processing apparatus to a second information processing apparatus, that amount of transfer of information from the first information processing apparatus to the second information processing apparatus is under a certain value.

5. The method according to claim 1, further comprising:
when a mode in which the generating of the one or more second packets is not executed when the one or more first packets are input into the second buffer is selected, suspending the first virtual machine is executed in response to the detecting that the second virtual machine is in the suspended state; and
not storing the one or more first packets into the first buffer.

6. The method according to claim 1, further comprising:
when the second virtual machine is not in the suspended state, storing the one or more first packets into the second buffer without storing the one or more first packets into the first buffer; and
generating the one or more second packets by replicating the one or more first packets stored in the second buffer.

7. An information processing apparatus configured to run a first virtual machine and a second virtual machine, the information processing apparatus comprising:
a memory; and
a processor coupled to the memory and configured to:
detect that the second virtual machine is in a suspended state, store one or more first packets into a first buffer during the suspended state,
input the one or more first packets stored in the first buffer into the second buffer after the suspended state is ended,
generate one or more second packets by replicating the one or more first packets input from the first buffer to the second buffer,
transmit the one or more first packets stored in the second buffer to the first virtual machine, and
transmit the one or more second packets to the second virtual machine.

8. The information processing apparatus according to claim 7, wherein
when the one or more first packets include a plurality of packets, the plurality of packets are stored into the first buffer in first order, and
the plurality of packets are input into the second buffer in the first order.

9. The information processing apparatus according to claim 7, wherein
the processor is further configured to detect a starting of live migration of the second virtual machine from the first information processing apparatus to a second information processing apparatus.

10. The information processing apparatus according to claim 7, wherein
the processor is further configured to detect, when the second virtual machine executes live migration from the first information processing apparatus to a second information processing apparatus, that amount of transfer of information from the first information processing apparatus to the second information processing apparatus is under a certain value.

11. The information processing apparatus according to claim 7, wherein
the processor is further configured to, when a mode in which the one or more second packet is not generated when the one or more first packets are input into the second buffer is selected, execute processing of suspending the first virtual machine in response to detecting that the second virtual machine is in the suspended state, and
the processor is further configured not to store the one or more first packets into the first buffer.

12. The information processing apparatus according to claim 7, wherein the processor is further configured to:
when the second virtual machine is not in the suspended state, store the one or more first packets into the second buffer without storing the one or more first packets into the first buffer, and
generate the one or more second packets by replicating the one or more first packets stored in the second buffer.

13. A non-transitory computer-readable storage medium storing a program that causes an information processing apparatus to execute a process, the information processing apparatus being configured to run a first virtual machine and a second virtual machine, the process comprising:
detecting that the second virtual machine is in a suspended state;
storing one or more first packets into a first buffer during the suspended state;
inputting the one or more first packets stored in the second buffer into a first buffer after the suspended state is ended;
generating one or more second packets by replicating the one or more first packets input from the first buffer to the second buffer;
transmitting the one or more first packets stored in the first buffer to the first virtual machine; and
transmitting the one or more second packets to the second virtual machine.

14. The non-transitory computer-readable storage medium according to claim 13, wherein
when the one or more first packets include a plurality of packets, the storing includes storing the plurality of packets into the first buffer in first order, and
the inputting includes inputting the plurality of packets into the second buffer in the first order.

15. The non-transitory computer-readable storage medium according to claim 13, wherein
the detecting includes detecting a starting of live migration of the second virtual machine from the first information processing apparatus to a second information processing apparatus.

16. The non-transitory computer-readable storage medium according to claim 13, wherein
the detecting includes detecting, when the second virtual machine executes live migration from the first information processing apparatus to a second information processing apparatus, that amount of transfer of information from the first information processing apparatus to the second information processing apparatus is under a certain value.

17. The non-transitory computer-readable storage medium according to claim 13, wherein the process further comprises:
when a mode in which the generating of the one or more second packets is not executed when the one or more first packets are input into the first buffer is selected, suspending the first virtual machine is executed in response to the detecting that the second virtual machine is in the suspended state of; and
not storing of the one or more first packets into the first buffer.

18. The non-transitory computer-readable storage medium according to claim 13, wherein the process further comprises:
when the second virtual machine is not in the suspended state, storing the one or more first packets into the second buffer without storing the one or more first packets into the first buffer; and
generating the one or more second packets by replicating the one or more first packets stored in the second buffer.
